(19) United States
(12) Patent Application Publication
(10) Pub. No.: US 2018/0218632 A1
(43) Pub. Date: Aug. 2, 2018

(54) METHODS AND SYSTEMS FOR CUSTOM SIGNAGE

(71) Applicants: Kelly Ivey, Plainfield, IN (US); Ann Zinyemba, Plainfield, IN (US)

(72) Inventors: Kelly Ivey, Plainfield, IN (US); Ann Zinyemba, Plainfield, IN (US)

(21) Appl. No.: 15/829,265

(22) Filed: Dec. 1, 2017

Related U.S. Application Data
(60) Provisional application No. 62/453,628, filed on Feb. 2, 2017.

(51) Int. Cl. G09B 11/04; B05D 1/32

(52) U.S. Cl. CPC G09B 11/04; G09F 7/00; B05D 1/32

(57) ABSTRACT

A method implementing custom signage workshops, including providing workshop materials, including stencil masks selected from a stencil database, pre-measured/pre-cut wooden substrates, sealer, quantities of different colors of artistic compositions, applicator, precision finishing tools, and precision applicators, and then sending the workshop materials and a teacher to a customers' home, teaching how to use a pressure member to adhere a stencil mask to a substrate, teaching application of sealer to the wooden substrate, teaching how to apply artistic composition to the sealed substrate to yield an artistic work, teaching when to remove the stencil mask from the substrate, teaching how to remove the stencil mask from the substrate, teaching how to use precision finishing tools to clean up artistic work, and teaching how to use the precision composition applicator to touch up artistic work. The plurality of quantities of artistic compositions includes at least fifty different colors.

### CROSS-REFERENCE TO RELATED APPLICATIONS

This patent application claims priority to co-pending U.S. provisional patent application Ser. No. 62/453,628, filed on Feb. 2, 2017.

### TECHNICAL FIELD

This novel technology relates to the field of signage. More specifically, the present technology is in the technical field of consumer custom signage creation with professional results.

### BACKGROUND

Artistic expression has long been a creative outlet for many individuals, and in recent years artistic expression has experienced a renaissance of sorts with do-it-yourself websites and videos where individuals share creative projects. However, the do-it-yourselfer must still research, locate, and procure all the materials necessary for each project, and even then face the challenges of ambiguous instructions, material incompatibly, and overall fit-and-finish of the final product being subpar. What is needed is a more efficient and effective platform for allowing individuals and/or groups to create high-quality artistic works while offering much lower barriers to entry.

The present novel technology addresses these needs.

### BRIEF DESCRIPTION OF THE DRAWINGS

FIG. 1 is a perspective view of an example signage materials associated with the present novel technology.

FIG. 2 is a perspective view of example stencil designs associated with the present novel technology.

FIG. 3 is perspective view of the present novel technology during a masking phase.

FIG. 4 is perspective view of the present novel technology during a staining phase.

FIG. 5 is perspective view of the present novel technology during a peeling phase.

FIG. 6 is perspective view of the present novel technology during a touch-up phase.

FIG. 7 is perspective view of some completed custom signage associated with the present novel technology.

FIG. 8 is a first block diagram of the present novel signage system.

FIG. 9 is a second block diagram of the present novel signage system in kit form.

FIG. 10 is first process flow chart for a first method associated with the present novel signage system.

FIG. 11 is second process flow chart for a second method associated with the present novel signage system.

FIG. 12A is third process flow chart for a third method associated with the present novel signage system.

FIG. 12B is fourth process flow chart for the third method associated with the present novel signage system.

FIG. 13 is fifth process flow chart for a fourth method associated with the present novel signage system.

Like reference numbers and designations in the various drawings indicate like elements.

The details of one or more embodiments of the subject matter described in this specification are set forth in the accompanying drawings and the description below. Other features, aspects, and advantages of the subject matter will become apparent from the description, the drawings, and the claims.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

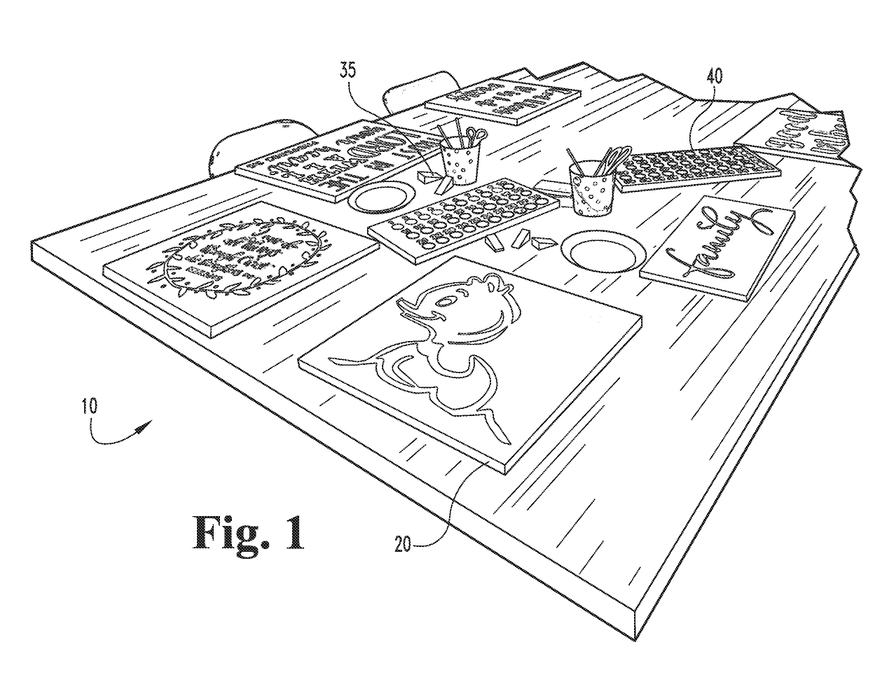

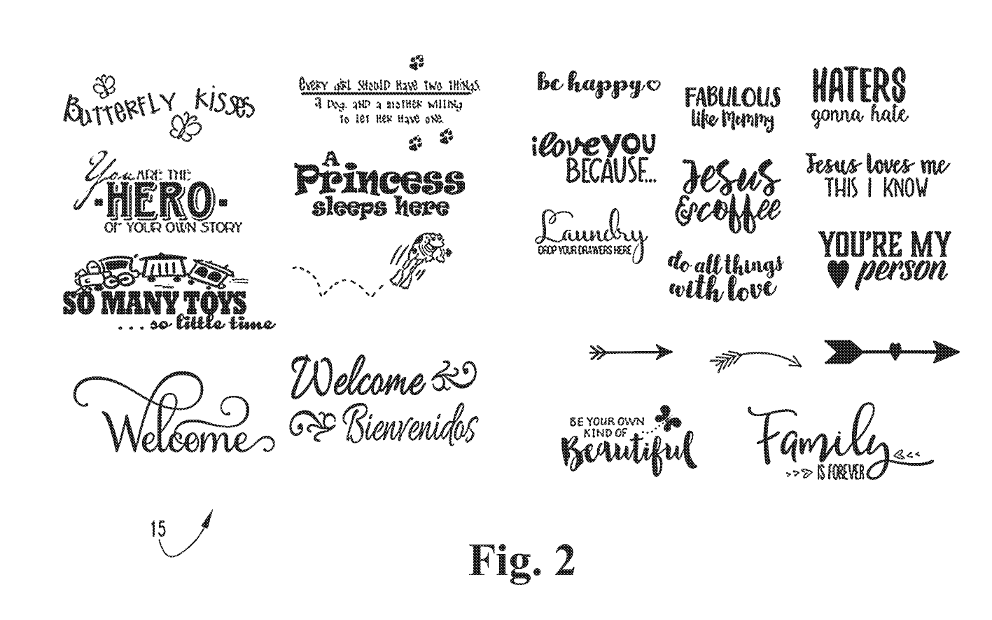

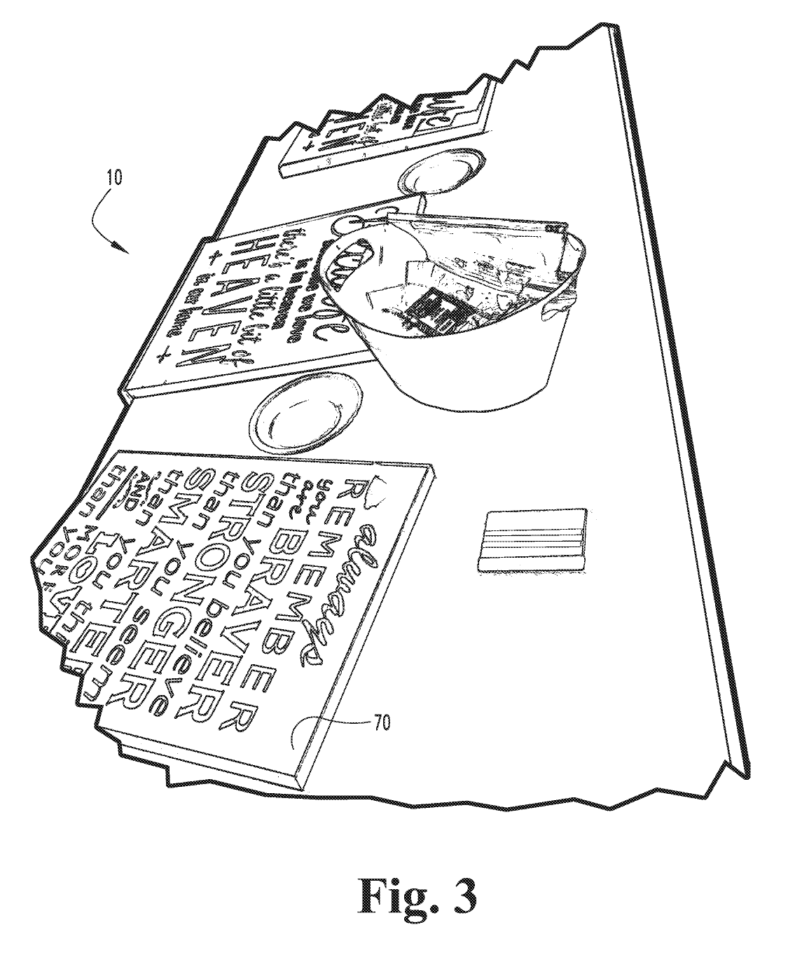

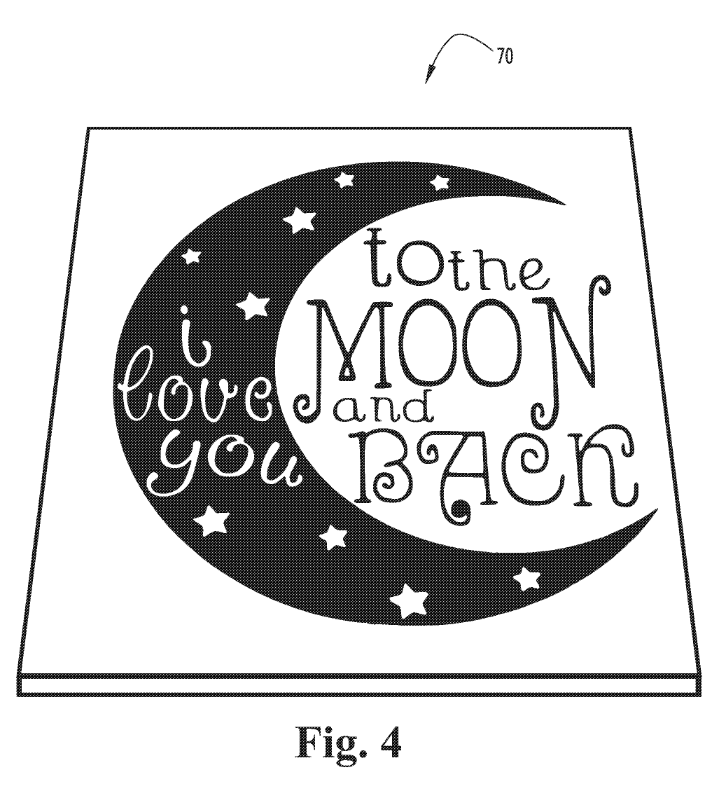

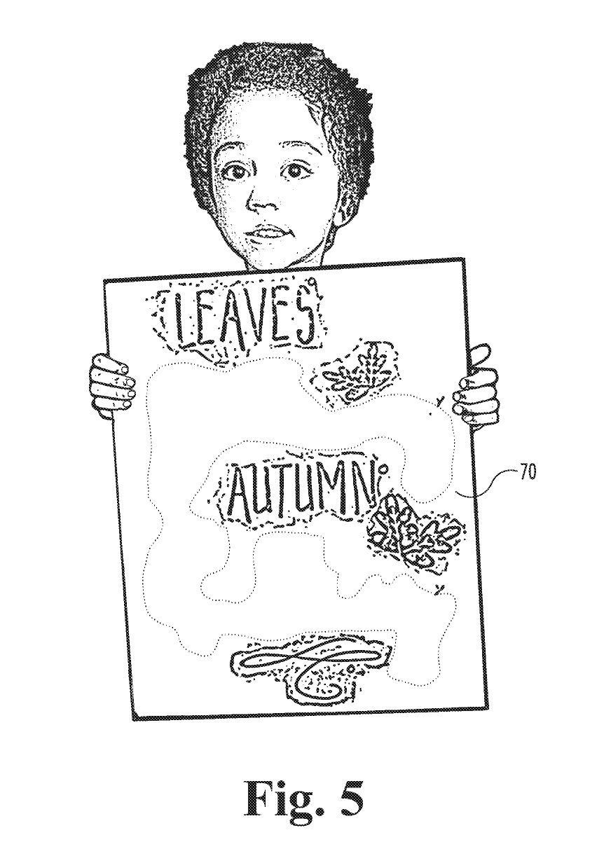

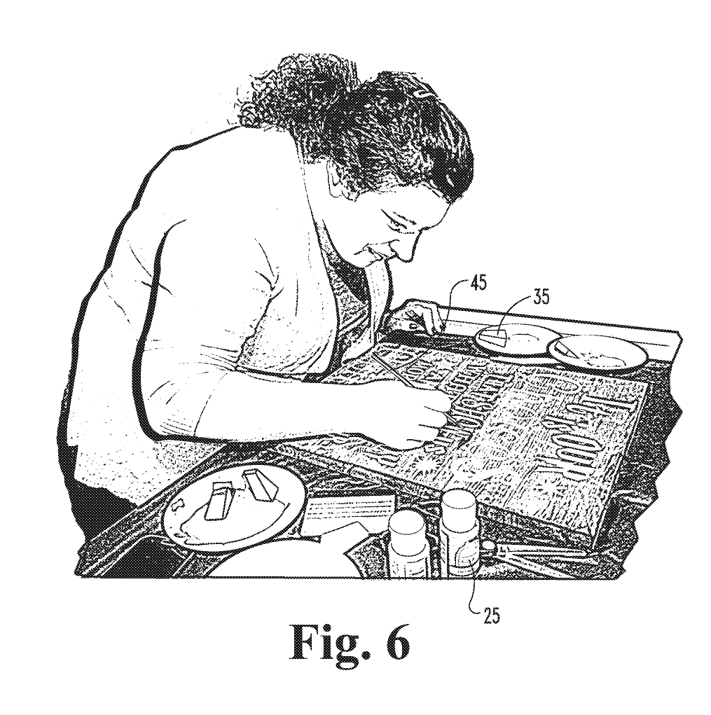

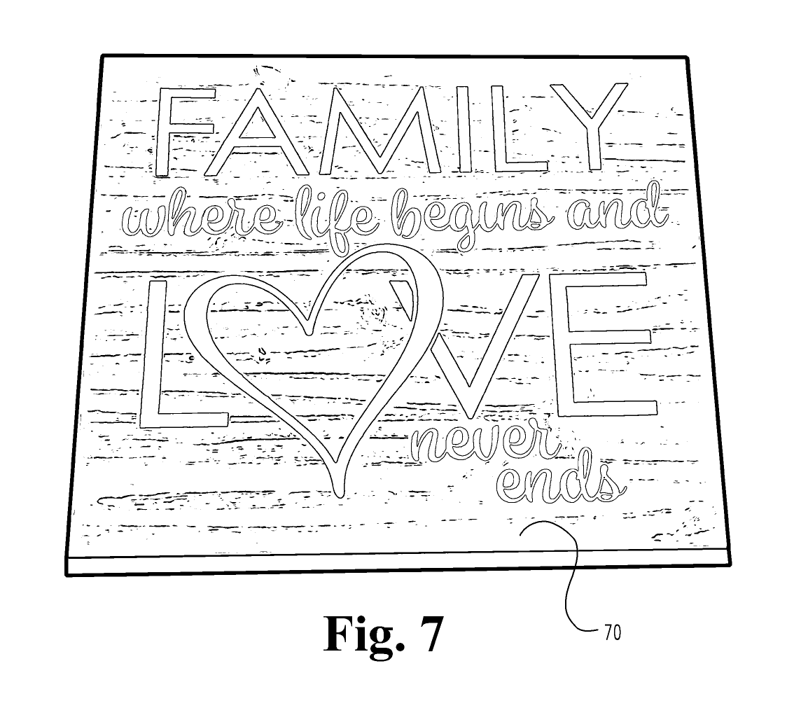

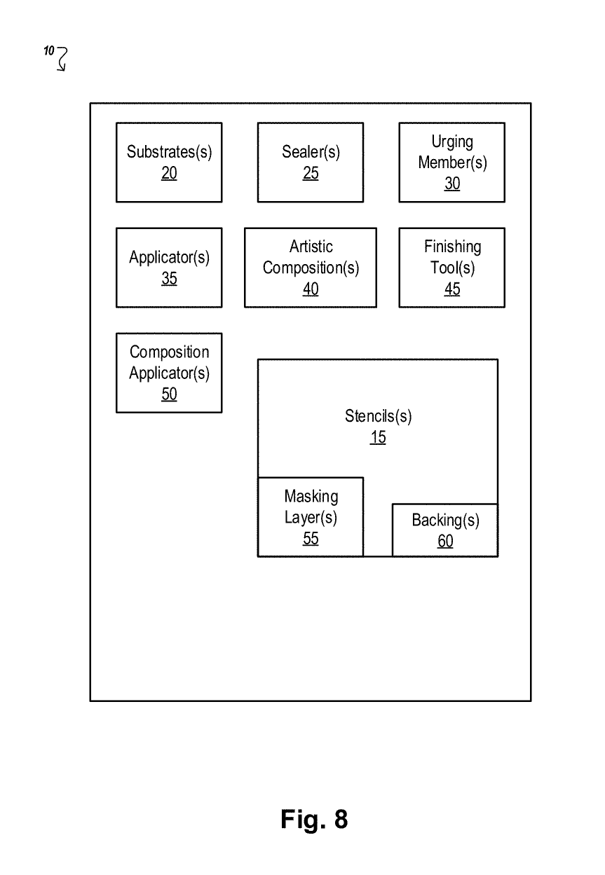

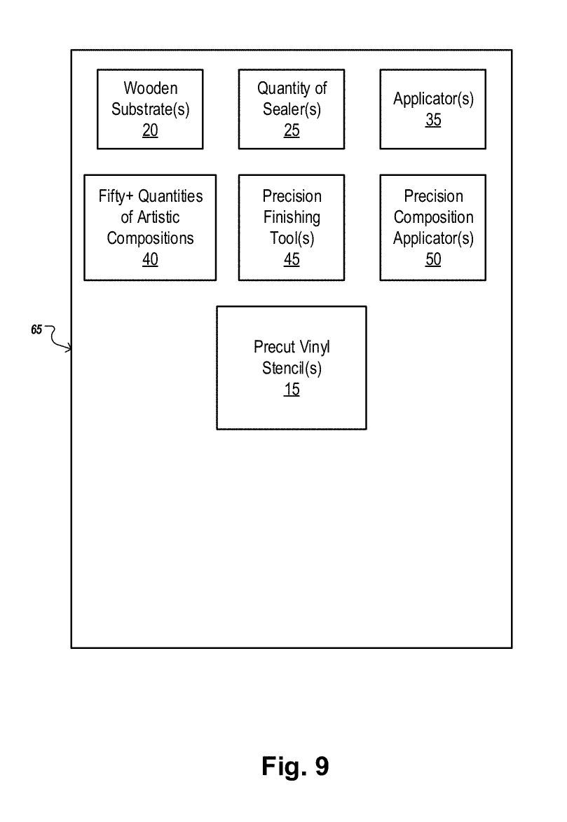

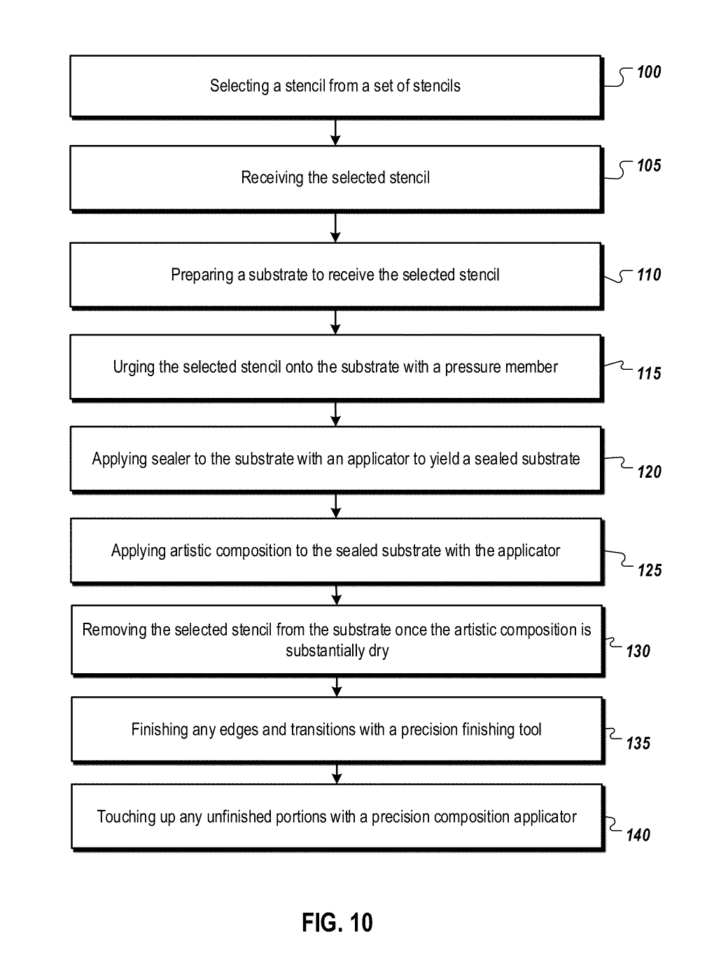

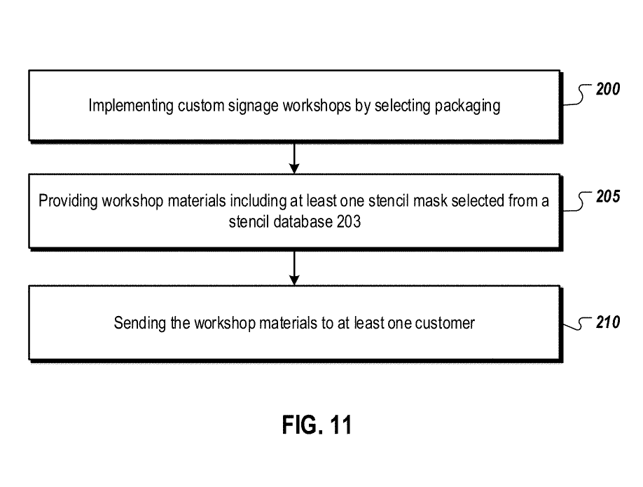

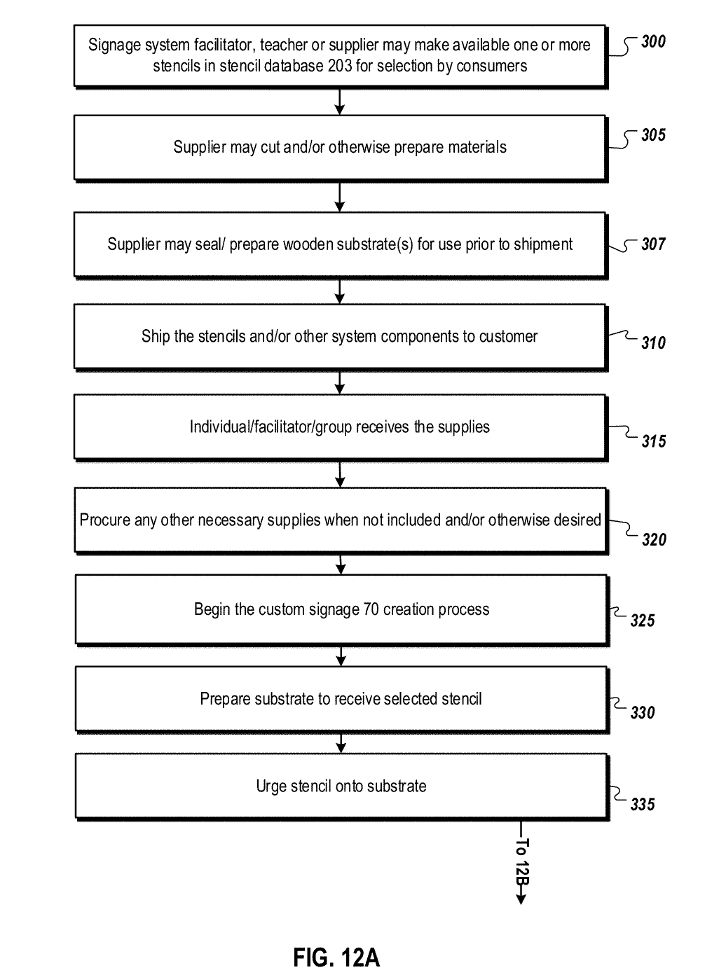

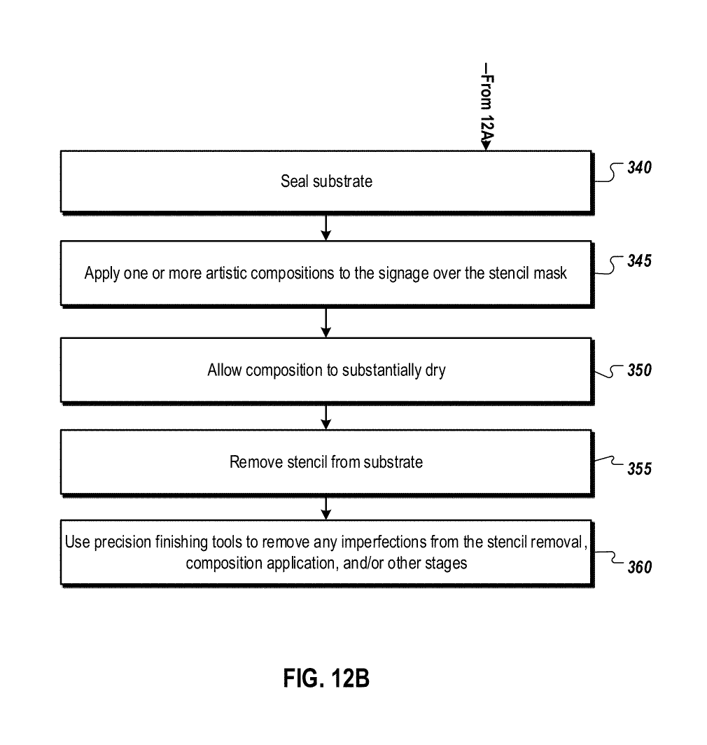

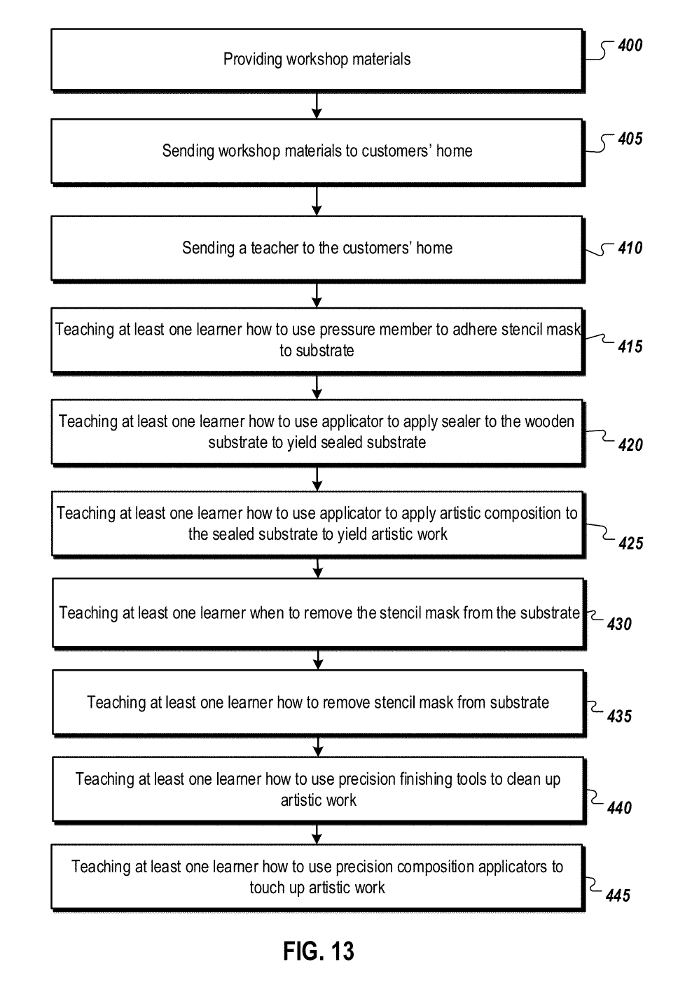

FIGS. 1-13 depict one embodiment of the present novel custom signage system 10, including components, phases, and product. Signage system 10 typically may include, but is not limited to, one or more stencils 15, substrates 20, sealers 25, urging members 30, applicators 35, artistic compositions 40, precision finishing tools 45, and/or precision composition applicators 50. In some implementations, signage system 10 may be in kit 65 form including, but not limited to, the herein-described components and/or subsets thereof.

Stencils 15 typically may be one or more masking layers 55 used with system 10, said masking layers 55 typically being made of vinyl, masking plastic, and/or the like. In some implementations, stencils 15 may have one or more adhesive layers and/or backings 60, while in other implementations, stencils 15 may simply be placed on and/or otherwise substantially connected (e.g., hook-and-loop fabric, adhesives, clamps, bands, and/or the like) to the substrate 20. Stencils 15 typically may be reusably removable and/or temporarily connected to the substrate 20, but in other implementations, stencils 15 may be more permanently connected (e.g., more permanently connected stencil may, for example, be removed using heat, solvent, and/or the like without damaging or otherwise affecting the substrate 20).

Substrate 20 typically may be wood or wood product, but may also be composites, plastics, paper, and/or other substrates capable of receiving artistic compositions 40. Substrates 20 typically may be premeasured, precut, and/or prefinished (e.g., sanded, rounded over, etc.), but in other implementations may be rough and/or finished by the receiving customer. Substrates 20 typically may be included in system 10 sent to a customer, but in other implementations, customers may provide their own substrates 20 where shipping may be difficult, customers have their preference of substrate 20 (e.g., hardwoods, etc.), and/or the like.

Further, one or more substrate sealers 25 typically may be used to seal the substrate 20 and prevent leeching of artistic composition 40 typically may be applied to the substrate 20 as well as increasing cleanup, touchup, and finalization of signage 10. For example, sealers may be, but are not limited to, MOD-PODGE (MOD-PODGE is a registered trademark of Plaid Enterprises, Inc., a Georgia corporation having offices at 3225 Westech Drive, Norcross, Ga. 30092). In some implementations, sealer 25 may be preapplied to substrate 20.

One or more urging members 30 typically may be used to urge stencil 15 to substrate 20. Such urging members 30 may be rollers, plastic scrapers, spatulas, cards, and/or the like. Urging members 30 typically may be used to evenly adhere stencil 15 to substrate 20 and/or remove contact imperfections.

One or more applicators 35 typically may be used with signage system 10. Such applicators 35 typically may be sponges, aerosols dispenser systems, brushes, rollers, and/or the like. These applicators 35 typically may be used to apply to apply one or more artistic compositions 40, typically to a sealed substrate 20. Artistic compositions 40 typically may be paints, but may also include, but are not limited to, stains, oils, inks, and/or the like.

Precision finishing tools 45 and/or precision composition applicators 50 typically may also be used with signage system 10. Finishing tools 45 may include, but are not limited to, precision knifes, hobby knifes, weeding tools, picks, and/or the like. These typically may be used to clean up edges of artistic composition 40 deposits on signage 10, typically after or during the stencil removal/peeling phase. Precision composition applicators 50 typically may be stain pens, paint pens, and/or the like that may further be used to touch up and/or otherwise finish signage 10.

In some other implementations, signage system 10 may be used in one or more methods. For example, one such method for creating custom signage 10 may include, but is not limited to, selecting 100 stencil 15 from set of stencils 15, receiving 105 selected stencil 15, preparing 110 substrate 20 to receive selected stencil 15, urging 115 selected stencil 15 onto substrate 20 with pressure member 30, applying 120 sealer 25 to substrate 20 with applicator 35, applying 125 artistic composition 40 to sealed substrate 20 with applicator 35, removing 130 selected stencil 15 from substrate 20 while artistic composition 40 is substantially dry, finishing 135 edges and transitions with precision finishing tool 45, and/or touching up 140 unfinished portions with precision composition applicator 50.

In a further method implementation, signage system 10 may be used for implementing 200 custom signage workshops by selecting packaging and/or 205 providing workshop materials, further including, but not limited to, at least one stencil mask 55 selected from a stencil database 203, substrate 20, substrate sealer 25, premeasured artistic composition 40, at least one applicator 35, at least one precision finishing tool 45, and at least one precision applicator 50, and then sending the workshop materials 210 to at least one customer.

In one nonlimiting example of using signage system 10, a signage system facilitator, teacher or supplier may make available 300 one or more stencils 15 in a stencil database 203 for selection by consumers. Once selected, the supplier may then cut and/or otherwise prepare 305 for shipment 310 the stencils 15 to the customer. Likewise, the supplier may seal or prepare 307 the wooden substrate(s) 20 for use prior to shipment. The supplier may also include other system 10 components (e.g., substrates 20, sealers 25, urging members 30, applicators 35, artistic compositions 40, precision finishing tools 45, and/or precision applicators 50) and then send 310 the signage supplies to a customer (e.g., an individual, a facilitator, a group, etc.). The individual/facilitator/group may then receive 315 the supplies, procure 320 any other necessary supplies (e.g., substrates, sealers, compositions, etc. when not included in suppliers and/or otherwise desired), and then begin 325 the custom signage 70 creation process. For individuals, this may simply be to start creating the signage 70 (e.g., preparing the substrate 20, applying the stencil 15, etc.), while for groups/facilitators this may mean to select and prepare a venue, collect fees, and/or the like.

The example signage creation process would then typically be started by preparing 330 the substrate 20 to receive the selected stencil 15 (e.g., sanding, sealing, dusting, and/or the like); urging 335 the stencil 15 onto the substrate 20; sealing 340 the substrate 20 (if not previously done); using applicators 35 to apply 345 one or more artistic compositions 40 to the signage 10 over the stencil mask 55; allowing 350 composition 40 to substantially dry; removing 355 stencil 15 from substrate 20; using precision finishing tools 45 to remove 360 any imperfections from the stencil removal, composition application, and/or the like; and/or using one or more precision composition applicators 50 to touch-up 365 composition deposits on signage and/or other imperfections (e.g., stain issues, substrate flaws, and/or the like. Thus, once completed, a customer has one or more professional-looking, completed custom signage 70.

Yet another example method may include steps including providing workshop materials 400 (e.g., one or more stencil masks selected from a stencil database 230, one or more pre-measured and pre-cut wooden substrates, one or more quantities of substrate sealer, and a plurality of quantities of premeasured artistic composition, where each respective quantity of artistic composition typically is a different color, one or more applicators, one or more precision finishing tools, and one or more precision applicators); sending the workshop materials to a customers' home 405; sending a teacher to the customers' home 410; teaching at least one learner how to use a pressure member to adhere a stencil mask to a substrate 415; teaching at least one learner how to use an applicator to apply sealer to the wooden substrate to yield a sealed substrate 420; teaching at least one learner how to use applicator to apply artistic composition to the sealed substrate to yield an artistic work 425; teaching at least one learner when to remove the stencil mask from the substrate 430; teaching at least one learner how to remove the stencil mask from the substrate 435; teaching at least one learner how to use precision finishing tools to clean up artistic work 440; and teaching at least one learner how to use precision composition applicators to touch up artistic work 445. In some further implementations, the plurality of quantities of artistic compositions typically may include at least fifty different colors.

While this document contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Thus, while the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A method for creating custom signage, comprising the steps of:
a) selecting a stencil from a set of stencils;
b) receiving the selected stencil;
c) preparing a substrate to receive the selected stencil;
d) urging the selected stencil onto the substrate with a pressure member;
e) applying sealer to the substrate with an applicator to yield a sealed substrate;
f) applying artistic composition to the sealed substrate with the applicator;
g) removing the selected stencil from the substrate once the artistic composition is substantially dry;
h) finishing any edges and transitions with a precision finishing tool; and
i) touching up any unfinished portions with a precision composition applicator.

2. A kit for creating custom signage, comprising:
at least one precut vinyl stencil;
at least one wooden substrate;
at least one quantity of sealer;
at least one applicator;
a plurality of quantities of respective artistic compositions;
at least one precision finishing tool; and
at least one precision composition applicator.

3. The kit of claim 2 wherein the respective artistic compositions are selected from the group comprising paints, stains and combinations thereof.

4. The kit of claim 3 wherein the plurality of quantities of respective artistic compositions includes at least fifty different colors.

5. A method implementing custom signage workshops, comprising:
a) providing workshop materials, wherein the workshop materials further comprise:
at least one stencil mask selected from a stencil database;
at least one pre-measured and pre-cut wooden substrate;
at least one quantity of substrate sealer;
a plurality of quantities of premeasured artistic composition, wherein each respective quantity of artistic composition is a different color;
at least one applicator;
at least one precision finishing tool; and
at least one precision applicator;
b) sending the workshop materials to a customers' home;
c) sending a teacher to the customers' home
d) teaching at least one learner how to use a pressure member to adhere a stencil mask to a substrate;
e) teaching at least one learner how to use an applicator to apply sealer to the wooden substrate to yield a sealed substrate;
f) teaching at least one learner how to use applicator to apply artistic composition to the sealed substrate to yield an artistic work;
g) teaching at least one learner when to remove the stencil mask from the substrate;
h) teaching at least one learner how to remove the stencil mask from the substrate;
i) teaching at least one learner how to use precision finishing tools to clean up artistic work; and
j) teaching at least one learner how to use precision composition applicators to touch up artistic work;
wherein the plurality of quantities of artistic compositions includes at least fifty different colors.
